(19) United States
(12) Patent Application Publication
(10) Pub. No.: US 2005/0100789 A1
(43) Pub. Date: May 12, 2005

(54) Nickel metal hydride storage battery

(76) Inventors: Tetsuyuki Murata, Kobe-city (JP); Shigekazu Yasuoka, Kobe-city (JP); Yoshifumi Magari, Kobe-city (JP); Tadayoshi Tanaka, Takatsuki-city (JP); Jun Ishida, Kobe-city (JP)

Correspondence Address: KUBOVCIK & KUBOVCIK, SUITE 710, 900 17TH STREET NW, WASHINGTON, DC, 20006, US

(21) Appl. No.: 10/964,741

(22) Filed: Oct. 15, 2004

(30) Foreign Application Priority Data
Oct. 16, 2003 (JP) 2003-356332
Aug. 3, 2004 (JP) 2004-226246

(51) Int. Cl. H01M 4/58; H01M 10/26; H01M 4/50

(52) U.S. Cl. 429/218.2; 429/206; 429/224; 429/231.1

(57) ABSTRACT

A nickel metal hydride storage battery including a positive electrode, a negative electrode including a hydrogen absorbing alloy, and an alkaline electrolyte, the hydrogen absorbing alloy containing at least a rare-earth element, magnesium, nickel and aluminum, and having an intensity ratio (I_{A}/I_{B}) of not smaller than 0.1 (where I_{A} represents an intensity of the highest peak in a range of 2θ=30°˜34° in an X-ray diffraction pattern using CuK_{α}-radiation as the X-ray source and I_{B} represents the intensity of the highest peak in a range of 2θ=40°˜44° in an X-ray diffraction pattern using CuK_{α}-radiation as the X-ray source), and the battery containing manganese in an amount of not greater than 1.0 wt % relative to the hydrogen absorbing alloy.

### FIELD OF THE INVENTION

The present invention relates to a nickel metal hydride storage battery comprising a positive electrode, a negative electrode comprising a hydrogen absorbing alloy and an alkaline electrolyte. More particularly, the present invention relates to an improved nickel metal hydride storage battery prepared using a hydrogen absorbing alloy having an intensity ratio (I_{A}/I_{B}) of not less than 0.1 (where I_{A} represents an intensity of the highest peak in a range of 2θ=30°˜34° in an X-ray diffraction pattern using CuK_{α}-radiation as the X-ray source and I_{B} represents the intensity of the highest peak in a range of 2θ=40°˜44°) and having sufficient cycle life even when a reduced amount of alkaline electrolyte is used to increase a capacity of the battery.

### BACKGROUND OF THE INVENTION

A nickel metal hydride storage battery including a hydrogen absorbing alloy as a negative electrode active material has recently become attractive as an alkaline storage battery from the view points of a high capacity and protecting the environment.

Nickel metal hydride storage batteries are used for portable equipment. It is required to improve the batteries so that they have increased efficiency.

As an alloy to be used for the negative electrode of a nickel metal hydride storage battery, a rare earth-nickel hydrogen absorbing alloy having a crystal structure of the CaCu₅ type as the main phase, a Laves phase hydrogen absorbing alloy containing Ti, Zr, V and Ni, and the like, have been commonly used.

However, such hydrogen absorbing alloys do not have sufficient hydrogen absorbing capacity, and it is difficult to increase the capacity of the nickel metal hydride storage battery.

A rare earth-nickel hydrogen absorbing alloy containing Mg and having a different crystal structure than the CaCu₅ type, has been proposed for increasing the hydrogen absorbing capacity (for example, Japanese Patent Laid-open Publication Nos. 11-323469 and 2002-164045).

The hydrogen absorbing alloy having such crystal structure tends to be oxidized, compared to the rare earth-nickel hydrogen absorbing alloy having the crystal structure of the CaCu₅ type as the main phase, and reacts with the alkaline electrolyte to consume the alkaline electrolyte.

Increasing an amount of each of a positive electrode and a negative electrode and decreasing an amount of the alkaline electrolyte have recently been used to increase capacity by increasing the energy density of the nickel metal hydride storage battery. However, such improvement causes a significant deterioration of cycle life of the battery by shortage of alkaline electrolyte caused by consumption of the alkaline electrolyte.

However, when an amount of alkaline electrolyte is increased, oxygen gas generated at the positive electrode becomes difficult to move to the negative electrode and is not used at the negative electrode. This causes an increase of internal pressure of the battery and a sudden expulsion of the alkaline electrolyte from the battery.

### OBJECT OF THE INVENTION

An object of the present invention is to solve the above-described problems of a nickel metal hydride storage battery including, as a negative electrode, a hydrogen absorbing alloy having a crystal structure other than that of the CaCu₅ type and which comprises a rare earth-nickel hydrogen absorbing alloy containing magnesium for increasing the hydrogen absorbing capacity.

In other words, the object of the present invention is to provide a nickel metal hydride storage battery having a sufficient cycle life by suppressing consumption of the alkaline electrolyte when an amount of the alkaline electrolyte is reduced.

### SUMMARY OF THE INVENTION

In a nickel metal hydride storage battery comprising a positive electrode, a negative electrode including a hydrogen absorbing alloy, and an alkaline electrolyte of the present invention, the hydrogen absorbing alloy comprises at least a rare-earth element, magnesium, nickel and aluminum, and has an intensity ratio (I_{A}/I_{B}) of not smaller than 0.1 (where I_{A} represents an intensity of the highest peak in a range of 2θ=30°˜34° in an X-ray diffraction pattern using CuK_{α}-radiation as the X-ray source and I_{B} represents the intensity of the highest peak in a range of 2θ=40°˜44° in an X-ray diffraction pattern using CuK_{α}-radiation as the X-ray source), and manganese is contained in the battery in an amount of not greater than 1.0 wt % relative to the hydrogen absorbing alloy.

### BRIEF DESCRIPTION OF THE DRAWINGS

FIG. 1 is a cross section of a nickel metal hydride storage battery prepared in the Examples and Comparative Examples.

[Explanation of Elements]

1: positive electrode
2: negative electrode
3: separator
4: battery can
5: positive electrode current collector (positive electrode lead)
6: seal plate
7: negative electrode current collector (negative electrode lead)
8: insulation packing
9: positive electrode external terminal
10: coil spring

### DETAILED EXPLANATION OF THE INVENTION

The amount of manganese in the nickel metal hydride storage battery of the present invention is preferably in a range of 0.3˜0.6 wt % based on the weight of the hydrogen absorbing alloy.

A hydrogen absorbing alloy represented by the formula, RE₁₋ₓMgₓNi_{y}Al_{z}Mₐ (wherein RE is a rare-earth element and M is an element other than a rare-earth element, Mg, Ni or Al, 0.10≦x≦0.30, 2.8≦y≦3.6, 0≦z≦0.30 and 3.0≦y+z+a≦3.6) can be used. A hydrogen absorbing alloy containing cobalt is preferable.

Manganese can be included in the battery by adding manganese or a manganese compound to the negative electrode and/or alkaline electrolyte or using a hydrogen absorbing alloy containing manganese.

As the manganese compound added to the alkaline electrolyte, manganese oxide, lithium manganese complex oxide, and the like can be illustrated.

As the manganese compound added to the negative electrode, a hydrogen absorbing alloy containing manganese is preferable. Especially, hydrogen absorbing alloy powder having an average diameter of particles of not greater than 35 μm is preferred.

When manganese is contained in the battery, manganese is deposited on a separator of the battery and consumption of the alkaline electrolyte is suppressed to improve characteristics of maintaining of the alkaline electrolyte in the separator.

However, if an amount of manganese included in the battery is too great, corrosion resistance of the hydrogen absorbing alloy is deteriorated. Therefore, the amount of manganese is not greater than 1.0 wt % and, preferably, is in a range of 0.3˜0.6 wt % relative to the hydrogen absorbing alloy.

As a result, manganese is deposited on the separator to improve the characteristic of maintaining the alkaline electrolyte in the separator and to inhibit consumption of the alkaline electrolyte so as to prevent deterioration of corrosion resistance of the hydrogen absorbing alloy and to obtain sufficient cycle life.

When the hydrogen absorbing alloy including cobalt is used for the negative electrode, cobalt eluted into the alkaline electrolyte is gradually deposited on the separator during charge and discharge cycles to cause short-circuiting between the positive and negative electrodes and to reduce discharge capacity and deteriorate cycle life. However, when manganese is included in a battery the present invention, manganese which has smaller conductivity than cobalt is deposited on the separator and inhibits (suppresses) reduction of discharge capacity and cycle life is improved.

When a hydrogen absorbing alloy including manganese as an element is used as the manganese compound added to the negative electrode, the hydrogen absorbing alloy including manganese participates in charge and discharge and inhibits reduction of capacity and deterioration of characteristics compared to the addition of manganese or other manganese compound to the negative electrode. Deterioration of characteristics such as corrosion resistance of the hydrogen absorbing alloy is improved when the hydrogen absorbing alloy including manganese is used alone as the hydrogen absorbing alloy for the negative electrode. When the hydrogen absorbing alloy including manganese as an element has an average diameter of particles of not greater than 35 μm, surface area of the hydrogen absorbing alloy particles is increased and dissolution of manganese and deposition of manganese on the separator are accelerated and cycle life is improved.

### DESCRIPTION OF PREFERRED EMBODIMENTS

Examples of a nickel metal hydride storage battery of the present invention are described below and are compared with those of comparative examples to show that an improved cycle life is obtained in the nickel metal hydride storage battery of the present invention. It is of course understood that the present invention is not limited to these examples and can be modified within the spirit and scope of the appended claims.

### EXAMPLE 1

[Preparation of Negative Electrode]

La, Pr and Nd as rare earth elements, and Zr, Mg, Ni, Al, Co and Mn in a mol ratio of 0.17:0.33:0.33:0.01:0.17:2.97:0.20:0.10:0.03 (La:Pr:Nd:Zr:Mg:Ni:Al:Co:Mn) were mixed, melted by a high frequency induction fusing (melting) method and cooled to prepare a hydrogen absorbing alloy ingot.

The ingot was treated at 950° C. for 10 hours under an argon atmosphere, was ground to a powder in a mortar in the atmosphere and was sieved to prepare a hydrogen absorbing alloy powder containing Mn as an element and having a particle diameter in the range of 25˜75 μm and being represented by the formula La_{0.17}Pr_{0.33}Nd_{0.33}Zr_{0.01}Mg_{0.17}Ni_{2.97}Al_{0.20}Co_{0.10}Mn_{0.03}. The amount of Mn relative to the total weight of the alloy was 0.53 wt %.

The hydrogen absorbing alloy powder was analyzed by an X-ray diffraction analysis device (Rigaku-sha: Model RINT2000). An X-ray diffraction pattern was obtained using CuK_{α}-radiation as the X-ray source, 2°/min of scanning speed, 0.02° of scanning step, 20˜80° of scanning field to obtain an intensity ratio (I_{A}/I_{B}), i.e., the ratio of an intensity of the highest peak in a range of 2θ=30°˜34° (I_{A}) to the intensity of the highest peak in a range of 2θ=40°˜44° (I_{B}). I_{A}/I_{B} was 0.77. The alloy had a crystal structure other than a CaCu₅ type.

100 Parts by weight of the hydrogen absorbing alloy, 0.5 part by weight of polyethylene oxide, 0.6 part by weight of polyvinylpyrrolidone were mixed to prepare a slurry. The slurry was evenly applied on both sides of an electrically-conductive core material comprising a nickel plated punching metal having a thickness of 0.05 mm, which was pressed after drying and cut to a size of 110×42.5 mm, as a negative electrode.

[Preparation of Positive Electrode]

100 Parts by weight of nickel hydroxide, and 0.1 part by weight of hydroxypropylcellulose were mixed to prepare a slurry. The slurry was filled in a nickel foam having a thickness of 1.7 mm and was pressed after drying and cut to a size of 71×42.5 mm to prepare a non-sintered nickel electrode as a positive electrode.

[Separator and Electrolyte]

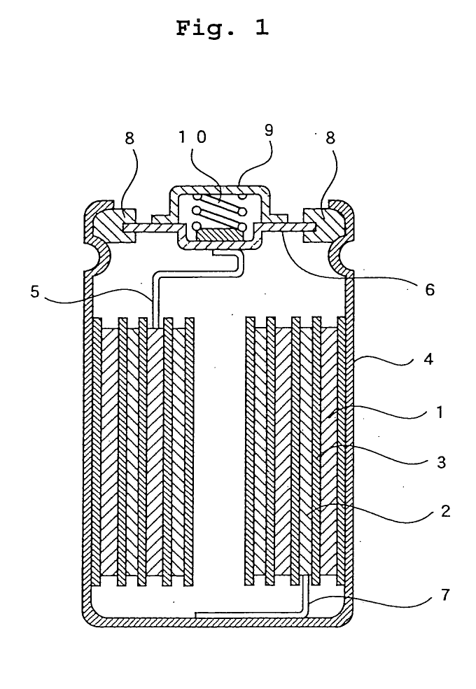

A polypropylene nonwoven fabric was used as a separator. 30 Wt % of an alkaline electrolyte containing KOH, NaOH and LiOH in a ratio of 10:1:2 by weight was used. A cylindrical nickel metal hydride storage battery having a designed capacity of 1500 mAh as shown in FIG. 1 was assembled.

As shown in FIG. 1, the separator 3 was inserted between the positive electrode 1 and the negative electrode 2 and was spirally rolled, and was placed in a battery can 4. 2.4 g of the alkaline electrolyte was poured into the battery can 4 and the can was sealed after an insulation packing 8 was placed between the battery can 4 and a seal plate 6. The positive electrode 1 was connected to the seal plate 6 through a positive electrode current collector (positive electrode lead) 5, and the negative electrode 2 was connected to the battery can 4 through a negative electrode current collector (negative electrode lead) 7. The battery can 4 and seal plate 6 were electrically insulated by the insulation packing 8. A coil spring 10 was placed between the seal plate 6 and a positive electrode external terminal 9. The coil spring 10 is compressed and releases gas from inside of the battery to the atmosphere when pressure in the battery unusually increases.

### COMPARATIVE EXAMPLE 1

La, Pr and Nd as rare earth elements, and Zr, Mg, Ni, Al and Co in a mol ratio of 0.17:0.33:0.33:0.01:0.17:3.00:0.20:0.10 (La:Pr:Nd:Zr:Mg:Ni:Al:Co) were mixed and treated in the same manner as in Example 1 to prepare a hydrogen absorbing alloy powder having a particle diameter in the range of 25˜75 μm and having the formula, La_{0.17}Pr_{0.33}Nd_{0.33}Zr_{0.01}Mg_{0.17}Ni_{3.00}Al_{0.20}Co_{0.10}.

I_{A}/I_{B} (where I_{A} and I_{B} are as defined in Example 1) of the alloy powder was measured in the same manner as in Example 1. I_{A}/I_{B} was 0.69. The alloy had a crystal structure other than a CaCu₅ type.

A nickel metal hydride storage battery of Comparative Example 1 was prepared in the same manner as in Example 1 except that the hydrogen absorbing alloy powder prepared above was used.

### COMPARATIVE EXAMPLE 2

La, Pr and Nd as rare earth elements, and Zr, Mg, Ni, Al, Co and Mn in a mol ratio of 0.17:0.33:0.33:0.01:0.17:2.94:0.20:0.10:0.06 (La:Pr:Nd:Zr:Mg:Ni:Al:Co:Mn) were mixed and treated in the same manner as in Example 1 to prepare a hydrogen absorbing alloy powder having a particle diameter in the range of 25˜75 μm and being represented by the formula La_{0.17}Pr_{0.33}Nd_{0.33}Zr_{0.01}Mg_{0.17}Ni_{2.94}Al_{0.20}Co_{0.10}Mn_{0.06}. The amount of Mn relative to the total weight of the alloy was 1.07 wt %.

I_{A}/I_{B} (where I_{A} and I_{B} are as defined in Example 1) of the alloy powder was measured in the same manner as in Example 1. I_{A}/I_{B} was 0.62. The alloy had a crystal structure other than a CaCu₅ type.

A nickel metal hydride storage battery of Comparative Example 2 was prepared in the same manner as in Example 1 except that the hydrogen absorbing alloy powder prepared above was used.

The batteries of Example 1 and Comparative Examples 1 and 2 were activated by charging at 150 mA for 16 hours and then discharging to a battery voltage of 1.0 V at 300 mA.

After the batteries were activated, the batteries were taken apart, and a maintaining rate of the alkaline electrolyte in the separator and an amount of Mn in the separator of each battery was measured. The results are shown in Table 1.

The maintaining rate (%) of the alkaline electrolyte in the separator means a ratio of amount of the alkaline electrolyte retained in the separator to the total amount of the alkaline electrolyte in the battery.

The separator was washed by water, and was dried. The amount of Mn in the separator was measured by obtaining an intensity of a peak (cps) corresponding to Mn by an X-ray fluorescent analyzer (Shimadzu: Model EDX-800) under an argon atmosphere.

TABLE 1

| | Content of | | | |
|---|---|---|---|---|
| | Mn relative | | Separator | |
| | to alloy | | Maintaining | |
| | (wt %) | I_{A}/I_{B} | Rate (%) | Mn (cps) |
| Example 1 | 0.53 | 0.77 | 11.5 | 0.935 |
| Comp. Ex. 1 | — | 0.69 | 11.0 | — |
| Comp. Ex. 2 | 1.07 | 0.62 | 11.1 | 5.302 |

As is clear from the results shown in Table 1, the nickel metal hydride storage battery prepared by using the hydrogen absorbing alloy powder of Example 1 containing Mn in an amount of 0.53 wt % had a higher maintaining rate of the alkaline electrolyte in the separator than batteries prepared using a hydrogen absorbing alloy powder not containing Mn (Comparative Example 1) and a hydrogen absorbing alloy powder containing Mn in an amount of 1.07 wt % (Comparative Example 2).

After the batteries of Example 1 and Comparative Examples 1 and 2 were activated as described above, the batteries were charged at 1500 mA until the highest battery voltages were reached, charging was continued until the voltages were reduced by 10 mV, and the batteries were left for one hour. Then the batteries were discharged to 1.0 V of battery voltage at 1500 mA, and were left for one hour (this charge and discharge cycle is considered one cycle). Charge and discharge of the batteries were repeated, and the number of cycles to reach 60% of the discharge capacity of the first cycle was measured. The results of cycle life of each battery are shown in Table 2 as an index when the cycle life of the battery of Comparative Example 1 is taken as 100.

After the batteries were charged and discharged for 150 cycles, the negative electrodes were removed from the batteries to measure oxygen concentration of each of the alloys. The results are shown in Table 2.

TABLE 2

| | Content of Mn | | |
|---|---|---|---|
| | relative to | | Oxygen Concentration |
| | alloy (wt %) | Cycle Life | in Alloy (%) |
| Example 1 | 0.53 | 108 | 1.492 |
| Comp. Ex. 1 | — | 100 | 1.429 |
| Comp. Ex. 2 | 1.07 | 90 | 1.775 |

As is clear from the results shown in Table 2, the nickel metal hydride storage battery prepared using the hydrogen absorbing alloy powder containing Mn in an amount of 0.53 wt % of Example 1 had improved cycle life as compared to the batteries prepared using the hydrogen absorbing alloy powder not containing Mn of Comparative Example 1 and the hydrogen absorbing alloy powder containing Mn in an amount of 1.07 wt % of Comparative Example 2.

Oxygen concentration of the nickel metal hydride storage battery of Comparative Example 2 which was prepared using the hydrogen absorbing alloy powder containing Mn in an amount of 1.07 wt % became higher after 150 cycles. It is believed that its cycle life was deteriorated because of corrosion of the hydrogen absorbing alloy.

### (EXAMPLES 2 AND 3 AND COMPARATIVE EXAMPLE 3)

Pr and Nd as rare earth elements, Zr, Mg, Ni, Al and Co in a mol ratio of 0.41:0.41:0.01:0.17:3.03:0.17:0.10 (Pr:Nd:Zr:Mg:Ni:Al:Co) were mixed and treated in the same manner as in Example 1 to prepare a hydrogen absorbing alloy powder having a particle diameter in the range of 25˜75 μm and represented by the formula, Pr_{0.41}Nd_{0.41}Zr_{0.01}Mg_{0.17}Ni_{3.03}Al_{0.17}Co_{0.10}.

I_{A}/I_{B} (where I_{A} and I_{B} are as defined in Example 1) of the alloy powder was measured in the same manner as in Example 1. I_{A}/I_{B} was 0.73. The alloy had a crystal structure other than a CaCu₅ type.

A manganese compound, LiMn₂O₄, was added to the hydrogen absorbing alloy powder in an amount of 0.5 wt % and 1.0 wt % in Examples 2 and 3, respectively. No manganese compound was added to the hydrogen absorbing alloy powder in Comparative Example 3. Amounts of Mn based on the hydrogen absorbing alloy were 0.3 wt % and 0.6 wt % in Examples 2 and 3, respectively.

Nickel metal hydride storage batteries of Examples 2 and 3 and Comparative Example 3 were prepared in the same manner as in Example 1 except that the hydrogen absorbing alloy powders prepared above were used.

The nickel metal hydride storage battery of Examples 2 and 3 and Comparative Example 3 were activated in the same manner as in Example 1. Charge and discharge of the batteries were repeated, and the number of cycles to reach 60% of the discharge capacity of the first cycle was measured in the same manner as in Example 1.

The results of cycle life of each battery are shown in Table 3 as an index when the cycle life of the battery of Comparative Example 3 is taken as 100.

Discharge capacities of the batteries of Example 2 and Comparative Example 3 at the initial cycle (Q1) were measured. The batteries were charged at 1500 mA until the maximum battery voltage was reached, charging was continued until the voltages were reduced 10 mV, and the batteries were left for 3 days at 60° C. Then the batteries were discharged to 1.0 V at 1500 mA to measure discharge capacity (Q2). Capacity maintenance rate (%) was calculated according to the expression below.
Capacity Maintenance Rate (%)=(Q2/Q1)×100

TABLE 3
Negative Electrode Alloy:
Pr_{0.41}Nd_{0.41}Zr_{0.01}Mg_{0.17}Ni_{3.03}Al_{0.17}Co_{0.10,}
I_{A}/I_{B} = 0.73

| | | | | Capacity |
|---|---|---|---|---|
| | | | | Maintenance |
| | Mn Compound | Mn (wt %) | Cycle Life | Rate |
| Example 2 | LiMn₂O₄ | 0.3 | 118 | 75.6 |
| Example 3 | LiMn₂O₄ | 0.6 | 114 | — |
| Comparative | — | — | 100 | 70.6 |
| Example 3 | | | | |

The nickel metal hydride storage batteries of Examples 2 and 3 wherein LiMn₂O₄ was added to the hydrogen absorbing alloy powder so that the amount of Mn was not greater than 1.0 wt % had improved cycle life as compared to the nickel metal hydride storage battery of Comparative Example 3 where no Mn was added to the hydrogen absorbing alloy powder. The battery of Example 2 wherein LiMn₂O₄ was added had a higher capacity maintenance rate than the battery of Comparative Example 3 wherein Mn was not added to the hydrogen absorbing alloy powder.

The cycle life of the battery of Example 3 (Mn was added in an amount of 0.6 wt % based on the hydrogen absorbing alloy) was not as good as that of the battery of Example 2 (Mn was added in an amount of 0.3 wt % based on the hydrogen absorbing alloy). It is believed that excess Mn dissolved in the alkaline electrolyte was transferred to the hydrogen absorbing alloy and was deposited and corrosion resistance of the hydrogen absorbing alloy was deteriorated.

### EXAMPLES 4˜6 AND COMPARATIVE EXAMPLE 4

[Preparation of Negative Electrode]

La, Pr and Nd as rare earth elements, Zr, Mg, Ni, Al and Co in a mol ratio of 0.17:0.41:0.24:0.01:0.17:3.03:0.17:0.10 (La:Pr:Nd:Zr:Mg:Ni:Al:Co) were mixed, melted by a high frequency induction fusing (melting) method and cooled to prepare a hydrogen absorbing alloy ingot.

The ingot was treated at 950° C. for 10 hours under an argon atmosphere, ground to a powder in a mortar in the atmosphere and was sieved to prepare a hydrogen absorbing alloy powder (A) without Mn having an average diameter of particles of 65 μm and represented by the formula, La_{0.17}Pr_{0.41}Nd_{0.24}Zr_{0.01}Mg_{0.17}Ni_{3.03}Al_{0.17}Cu_{0.10}.

The hydrogen absorbing alloy powder was analyzed by an X-ray diffraction analysis device (Rigaku-sha: Model RINT2000). An X-ray diffraction pattern was obtained using CuK_{α}-radiation as the X-ray source, 2′/min of scanning speed, 0.02° of scanning step, 20°˜80° of scanning field to obtain an intensity ratio (I_{A}/I_{B}) which is a ratio of an intensity of the highest peak in a range of 2θ=30°˜34° (I_{A}) to the intensity of the highest peak in a range of 2θ=40°˜44° (I_{B}). I_{A}/I_{B} was 0.76. The alloy had a crystal structure other than a CaCu₅ type.

La, Ce, Pr and Nd as rare earth elements, and Ni, Al, Co and Mn in a mol ratio of 0.80:0.14:0.04:0.02:3.89:0.29:0.90:0.10 (La:Ce:Pr:Nd:Ni:Al:Co:Mn) were mixed, melted by a high frequency induction fusing (melting) method and cooled to prepare a hydrogen absorbing alloy ingot containing Mn.

The ingot was treated at 950° C. for 10 hours under an argon atmosphere, ground to a powder in a mortar in the atmosphere and was sieved to prepare hydrogen absorbing alloy powders containing Mn as an element and having an average diameter of particles of 55 μm (B1) and an average diameter of particles of 35 μm (B2) and represented by the formula, La_{0.80}Ce_{0.14}Pr_{0.04}Nd_{0.02}Ni_{3.89}Al_{0.29}Co_{0.90}Mn_{0.10}.

In Example 4, the hydrogen absorbing alloy powder (A) and the hydrogen absorbing alloy powder (B1) were mixed at a ratio of 95:5 by weight. In Example 5, the hydrogen absorbing alloy powder (A) and the hydrogen absorbing alloy powder (B2) were mixed at a ratio of 95:5 by weight. In Example 6, the hydrogen absorbing alloy powder (A) and the hydrogen absorbing alloy powder (B1) were mixed at a ratio of 90:10 by weight. In comparative Example 4, the hydrogen absorbing alloy powder (A) alone was used. Content of Mn to the alloy or alloy mixtures are, 0.07 wt % in Examples 4 and 5, 0.14 wt % in Example 6, and none in Comparative Example 4, as shown in Table 4.

100 Parts by weight of the hydrogen absorbing alloy or mixture of alloys, 0.5 part by weight of polyethylene oxide, and 0.6 part by weight of polyvinylpyrrolidone were mixed to prepare a slurry. The slurry was evenly applied on both sides of an electrically-conductive core material comprising a nickel plated punching metal having a thickness of 0.05 mm, which was pressed after drying and cut to a size of 113×43.8 mm, as a negative electrode.

[Preparation of Positive Electrode]

100 Parts by weight of nickel hydroxide, and 0.1 part by weight of hydroxypropylcellulose were mixed to prepare a slurry. The slurry was filled in a nickel foam having a thickness of 1.7 mm and was pressed after drying and cut to a size of 73×43.8 mm to prepare a non-sintered nickel electrode as a positive electrode in the same manner as Example 1.

[Separator and Electrolyte]

A polypropylene nonwoven fabric was used as a separator. 30 Wt % of an alkaline electrolyte containing KOH, NaOH and LiOH in a ratio of 10:1:2 by weight was used as the electrolyte.

Cylindrical nickel metal hydride storage batteries having a designed capacity of 2100 mAh as shown in FIG. 1 were assembled.

The batteries of Examples 4˜6 and Comparative Example 4 were activated by charging at 210 mA for 16 hours and then discharging to a battery voltage of 1.0 V at 420 mA.

After the batteries of Examples 4˜6 and Comparative Example 4 were activated as described above, the batteries were charged at 2100 mA until the highest battery voltages were reached, charging was continued until the voltages were reduced by 10 mV, and the batteries were left for twenty minutes. Then the batteries were discharged to 1.0 V of battery voltage at 2100 mA, and were left for ten minutes (this charge and discharge cycle is considered one cycle). Charge and discharge of the batteries were repeated, and the number of cycles to reach 60% of the discharge capacity of the first cycle was measured.

The results of cycle life of the batteries are shown in Table 4 as an index when the cycle life of the battery of Comparative Example 4 is taken as 100.

TABLE 4
Negative Electrode Alloy:
La_{0.17}Pr_{0.41}Nd_{0.24}Zr_{0.01}Mg_{0.17}Ni_{3.03}Al_{0.17}Co_{0.10}
I_{A}/I_{B} = 0.76

| | Alloy containing Mn | | | |
|---|---|---|---|---|
| | | Average | | |
| | | Diameter | | |
| | Addition | (μm) | Mn (wt %) | Cycle Life |
| Example 4 | Yes | 55 | 0.07 | 110 |
| Example 5 | Yes | 35 | 0.07 | 115 |
| Example 6 | Yes | 55 | 0.14 | 119 |
| Comparative | No | — | — | 100 |
| Example 4 | | | | |

The nickel metal hydride storage batteries of Examples 4˜6 wherein the hydrogen absorbing alloy powder (B1 or B2) containing Mn was added to the hydrogen absorbing alloy powder (A) not containing Mn were used had improved cycle life as compared to the nickel metal hydride storage battery of Comparative Example 4 wherein hydrogen absorbing alloy powder (A) alone was used.

Among the nickel metal hydride storage batteries of Examples 4˜6, the battery of Example 6 wherein more Mn was added (0.14 wt %) had better cycle life as compared to the batteries of Examples 4 and 5 wherein the Mn content was 0.07 wt %.

When comparing the batteries of Examples 4 and 5 wherein the same amount of Mn was contained, the battery of Example 5 prepared using the hydrogen absorbing alloy powder (B2) having a smaller average diameter of particles (35 μm) had more improved cycle life than the battery of Example 4 prepared using the hydrogen absorbing alloy powder (B2) having a larger average diameter of particles (55 μm).

### EXAMPLES 7˜11 AND COMPARATIVE EXAMPLE 5

[Preparation of Negative Electrode]

A hydrogen absorbing alloy powder having particle diameters in a range of 25˜75 μm and represented by the formula, La_{0.17}Pr_{0.41}Nd_{0.24}Zr_{0.01}Mg_{0.17}Ni_{3.03}Al_{0.17}Co_{0.10}, was prepared in the same manner as in Example 4˜6 and Comparative Example 4. The prepared alloy had the same I_{A}/I_{B} of 0.76 as the hydrogen absorbing alloy powder (A) used in Example 4˜6 and Comparative Example 4. The alloy had also a crystal structure other than a CaCu₅ type.

A Mn compound was added to the alloy in Examples 7˜11. In Example 7, Mn was added at 0.50 wt %; in Example 8, MnO was added at 0.50 wt %; in Example 9, Mn₂O₃ was added at 0.50 wt %; in Example 10, LiMnO₃ was added at 0.50 wt %; and in Example 11, Li_{0.29}Mn₂O₄ was added at 0.50 wt %. No Mn compound was added to the alloy in Comparative Example 5. Amounts of Mn relative to the hydrogen absorbing alloy were 0.50 wt % in Example 7, 0.32 wt % in Example 8, 0.35 wt % in Example 9, 0.29 wt % in Example 10 and 0.31 wt % in Example 11.

Cylindrical nickel metal hydride storage batteries having a designed capacity of 2100 mAh as shown in FIG. 1 were assembled in the same manner as in Example 4˜6 and Comparative Example 4 except that the hydrogen absorbing alloys prepared above were used.

The batteries of Examples 7˜11 and Comparative Example 5 were activated by charging at 210 mA for 16 hours and then discharging to a battery voltage of 1.0 V at 420 mA in the same manner as in Example 4˜6 and Comparative Example 4.

After the batteries of Examples 7˜11 and Comparative Example 5 were activated as described above, the batteries were treated in the same manner as in Example 4˜6 and Comparative Example 4. I.e., the batteries were charged at 2100 mA until the highest battery voltages were reached, charging was continued until the voltages were reduced 10 mV, and the batteries were left for twenty minutes. Then the batteries were discharged to 1.0 V of battery voltage at 2100 mA, and were left for ten minutes (this charge and discharge cycle is considered one cycle). Charge and discharge of the batteries were repeated, and the number of cycles to reach 60% of the discharge capacity of the first cycle was measured.

The results of cycle life of the batteries are shown in Table 5 as an index when the cycle life of the battery of Comparative Example 5 is taken as 100.

TABLE 5
Negative Electrode Alloy:
La_{0.17}Pr_{0.41}Nd_{0.24}Zr_{0.01}Mg_{0.17}Ni_{3.03}Al_{0.17}Co_{0.10}
I_{A}/I_{B} = 0.76

| | Mn Compound | | | |
|---|---|---|---|---|
| | | Amount | | |
| | | (wt %) | Mn (wt %) | Cycle Life |
| Example 7 | Mn | 0.50 | 0.50 | 104 |
| Example 8 | MnO | 0.50 | 0.32 | 106 |
| Example 9 | Mn₂O₃ | 0.50 | 0.35 | 107 |
| Example 10 | LiMnO₂ | 0.50 | 0.29 | 106 |
| Example 11 | Li_{0.29}Mn₂O₄ | 0.50 | 0.31 | 111 |
| Comparative | — | — | — | 100 |
| Example 5 | | | | |

The nickel metal hydride storage batteries of Examples 7˜11 wherein Mn or the Mn compound was added to the hydrogen absorbing alloy which did not contain Mn had improved cycle lives as compared to the nickel metal hydride storage batteries of Comparative Example 5 wherein Mn or an Mn compound was not added to the hydrogen absorbing alloy.

### EXAMPLES 12 AND 13 AND COMPARATIVE EXAMPLE 6

[Preparation of Negative Electrode]

La, Pr and Nd as rare earth elements, and Zr, Mg, Ni and Al in a mol ratio of 0.17:0.33:0.33:0.01:0.17:3.10:0.20 (La:Pr:Nd:Zr:Mg:Ni:Al) were mixed, melted by a high frequency induction fusing (melting) method and cooled to prepare a hydrogen absorbing alloy ingot.

The ingot was treated at 950° C. for 10 hours under an argon atmosphere, was ground to a powder in a mortar in the atmosphere and was sieved to prepare a hydrogen absorbing alloy powder without Co and Mn having particle diameters in a range of 25˜75 μm and represented by the formula, La_{0.17}Pr_{0.33}Nd_{0.33}Zr_{0.01}Mg_{0.17}Ni_{3.10}Al_{0.20}.

The hydrogen absorbing alloy powder was analyzed by an X-ray diffraction analysis device (Rigaku-sha: Model RINT2000). An X-ray diffraction pattern was obtained using CuK_{α}-radiation as the X-ray source, 2°/min of scanning speed, 0.02° of scanning step, 20°˜80° of scanning field to obtain intensity ratio (I_{A}/I_{B}). I_{A}/I_{B} was 0.73. The alloy had a crystal structure other than a CaCu₅ type.

A Mn compound was added to the alloy in Examples 12 and 13. In Example 12, LiMn₂O₄ was added at 0.25 wt %; and in Example 12, LiMn₂O₄ was added at 0.50 wt %. No Mn compound was added to the alloy in Comparative Example 6. Amounts of Mn relative to the hydrogen absorbing alloy were 0.15 wt % in Example 12 and 0.30 wt % in Example 13.

Cylindrical nickel metal hydride storage batteries having a designed capacity of 2100 mAh as shown in FIG. 1 were assembled in the same manner as Example 4˜6 and Comparative Example 4 except that the hydrogen absorbing alloys prepared above were used.

The batteries of Examples 12 and 13 and Comparative Example 6 were activated by charging at 210 mA for 16 hours and then discharging to a battery voltage of 1.0 V at 420 mA in the same manner as in Example 4˜6 and Comparative Example 4.

After the batteries of Examples 12 and 13 and Comparative Example 6 were activated as described above, the batteries were treated in the same manner as Example 4˜6 and Comparative Example 4. I.e., the batteries were charged at 2100 mA until the highest battery voltages were reached, charging was continued until the voltages were reduced 10 mV, and the batteries were left for twenty minutes. Then the batteries were discharged to 1.0 V of battery voltage at 2100 mA, and were left for ten minutes (this charge and discharge cycle is considered one cycle). Charge and discharge of the batteries were repeated, and the number of cycles to reach 60% of the discharge capacity of the first cycle was measured.

The results of cycle life of the batteries are shown in Table 6 as an index when the cycle life of the battery of Comparative Example 6 is taken as 100.

TABLE 6
Negative Electrode Alloy:
La_{0.17}Pr_{0.33}Nd_{0.33}Zr_{0.01}Mg_{0.17}Ni_{3.10}Al_{0.20}
I_{A}/I_{B} = 0.73

| | Mn Compound | | | |
|---|---|---|---|---|
| | | Amount | | |
| | | (wt %) | Mn (wt %) | Cycle Life |
| Example 12 | LiMn₂O₄ | 0.25 | 0.15 | 106 |
| Example 13 | LiMn₂O₄ | 0.50 | 0.30 | 115 |
| Comparative | — | — | — | 100 |
| Example 6 | | | | |

The nickel metal hydride storage batteries of Examples 12 and 13 wherein LiMn₂O₄ was added to the hydrogen absorbing alloy in which Mn and Co were not contained had improved cycle lives as compared to the nickel metal hydride storage batteries of Comparative Example 6 wherein LiMn₂O₄ was not added to the hydrogen absorbing alloy.

When the nickel metal hydride storage batteries of Examples 12 and 13 were compared to the nickel metal hydride storage batteries of Examples 2 and 3, the nickel metal hydride storage batteries of Examples 2 and 3, wherein the hydrogen absorbing alloy contained Co, had significantly improved cycle lives.

### ADVANTAGES OF THE INVENTION

The present invention can provide a nickel metal hydride storage battery having a high capacity as compared to a battery comprising a rare earth-nickel hydrogen absorbing alloy having a crystal structure of the CaCu₅ type as the main phase.

1. A nickel metal hydride storage battery comprising a positive electrode, a negative electrode comprising a hydrogen absorbing alloy, and an alkaline electrolyte,
wherein the hydrogen absorbing alloy comprises at least a rare-earth element, magnesium, nickel and aluminum, and has an intensity ratio (I_{A}/I_{B}) of not smaller than 0.1, where 1A represents an intensity of the highest peak in a range of 2θ=30°˜34° in an X-ray diffraction pattern using CuK_{α}-radiation as the X-ray source and I_{B} represents the intensity of the highest peak in a range of 2θ=40°˜44° in an X-ray diffraction pattern using CuK_{α}-radiation as the X-ray source; and
manganese is contained in the battery in an amount of not greater than 1.0 wt % relative to the hydrogen absorbing alloy.

2. The nickel metal hydride storage battery according to claim 1, wherein the mount of manganese in the battery is in a range of 0.3˜0.6 wt % based on the amount of the hydrogen absorbing alloy.

3. The nickel metal hydride storage battery according to claim 1, wherein the hydrogen absorbing alloy contains cobalt as an element of the alloy.

4. The nickel metal hydride storage battery according to claim 2, wherein the hydrogen absorbing alloy contains cobalt as an element of the alloy.

5. The nickel metal hydride storage battery according to claim 1, wherein the manganese is included in the negative electrode or the alkaline electrolyte in the form of manganese or a manganese compound.

6. The nickel metal hydride storage battery according to claim 2, wherein the manganese is included in the negative electrode or the alkaline electrolyte in the form of manganese or a manganese compound.

7. The nickel metal hydride storage battery according to claim 3, wherein the manganese is included in the negative electrode or the alkaline electrolyte in the form of manganese or a manganese compound.

8. The nickel metal hydride storage battery according to claim 4, wherein the manganese is included in the negative electrode or the alkaline electrolyte in the form of manganese or a manganese compound.

9. The nickel metal hydride storage battery according to claim 5, wherein the manganese compound is at least one of a manganese oxide or a lithium manganese complex oxide.

10. The nickel metal hydride storage battery according to claim 6, wherein the manganese compound is at least one of a manganese oxide or a lithium manganese complex oxide.

11. The nickel metal hydride storage battery according to claim 7, wherein the manganese compound is at least one of a manganese oxide or a lithium manganese complex oxide.

12. The nickel metal hydride storage battery according to claim 8, wherein the manganese compound is at least one of a manganese oxide or a lithium manganese complex oxide.

13. The nickel metal hydride storage battery according to claim 5, wherein the manganese compound is included in the negative electrode and is a hydrogen absorbing alloy comprising manganese as an element.

14. The nickel metal hydride storage battery according to claim 6, wherein the manganese compound is included in the negative electrode and is a hydrogen absorbing alloy comprising manganese as an element.

15. The nickel metal hydride storage battery according to claim 7, wherein the manganese compound is included in the negative electrode and is a hydrogen absorbing alloy comprising manganese as an element.

16. The nickel metal hydride storage battery according to claim 8, wherein the manganese compound is included in the negative electrode and is a hydrogen absorbing alloy comprising manganese as an element.

17. The nickel metal hydride storage battery according to claim 13, wherein the hydrogen absorbing alloy containing manganese has an average diameter of particles of not greater than 35 μm.

18. The nickel metal hydride storage battery according to claim 14, wherein the hydrogen absorbing alloy containing manganese has an average diameter of particles of not greater than 35 μm.

19. The nickel metal hydride storage battery according to claim 15, wherein the hydrogen absorbing alloy containing manganese has an average diameter of particles of not greater than 35 μm.

20. The nickel metal hydride storage battery according to claim 16, wherein the hydrogen absorbing alloy containing manganese has an average diameter of particles of not greater than 35 μm.

21. The nickel metal hydride storage battery according to claim 1, wherein the hydrogen absorbing alloy contains manganese as an element.

22. The nickel metal hydride storage battery according to claim 2, wherein the hydrogen absorbing alloy contains manganese as an element.

23. The nickel metal hydride storage battery according to claim 3, wherein the hydrogen absorbing alloy contains manganese as an element.

24. The nickel metal hydride storage battery according to claim 4, wherein the hydrogen absorbing alloy contains manganese as an element.
